(19) United States
(12) Patent Application Publication
(10) Pub. No.: US 2020/0022530 A1
(43) Pub. Date: Jan. 23, 2020

(54) FOOD SEARING TOOL

(71) Applicant: Michael W. Sandeen, Acampo, CA (US)

(72) Inventor: Michael W. Sandeen, Acampo, CA (US)

(21) Appl. No.: 16/399,818

(22) Filed: Apr. 30, 2019

Related U.S. Application Data
(60) Provisional application No. 62/700,344, filed on Jul. 19, 2018.

(51) Int. Cl. A47J 37/06

(52) U.S. Cl. CPC A47J 37/0611; A47J 2202/00

(57) ABSTRACT

A top plate and bottom plate are stacked together to form the food searing tool, for simultaneously heating both top and bottom sides of a food item. The plates are heated to a similar temperature. A food item is placed between the plates. The plates and food item thereon are removed from heat, so that the only heating of the food item occurs by residual heat within the top and bottom plates transferring from the plates into the food item. This heating involves a similar amount being transferred down into the food item from the top plate as is transferred up into the food item from the bottom plate. Alternative embodiments include various forms of handles and guideposts/bars, as well as a thermometer in the top plate and a trough to capture grease.

### CROSS-REFERENCE TO RELATED APPLICATIONS

This application claims benefit under Title 35, United States Code § 119(e) of U.S. Provisional Application No. 62/700,344 filed on Jul. 19, 2018.

### FIELD OF THE INVENTION

The following invention relates to food cooking apparatuses. More particularly, this invention relates to pans or plates which can be heated from a variety of heat sources, and which includes both a top plate and a bottom plate which are heated and then placed adjacent to a food item to cook the food item by heat transfer from both the top plate and the bottom plate, simultaneously on opposite sides of the food item.

### BACKGROUND OF THE INVENTION

Searing is a popular method for browning and caramelizing the outside portion of meat. This method also locks in the juices and flavor in meat. The present common searing method involves heating a pan, grill or griddle to high temperature, often around 350° F. to 500° E After the high temperature is achieved, the meat is placed one side down on the hot cooking surface for a brief period, usually around 1-2 minutes then the meat is flipped to the opposite side onto the cooking surface for another 1-2 minutes. After both sides of the meat have been seared the meat can be transferred to a barbecue grill, placed in the oven, on a griddle or in a frying pan to continue the cooking process until the meat has reached the proper internal temperature or doneness. This searing and cooking method requires constant flipping of the meat and an unnecessary amount of cooking time, which tends to dry out the meat allowing it to lose moisture and flavor.

Cooking meat not only performs a sanitary function, but it also causes the molecules in the food to undergo various chemical reactions, generally involving partial decomposition and/or oxidation. These specific chemical reactions are often characterized in bulk as a Maillard Reaction, described as a chemical reaction which browns foods and gives it its flavor. This Maillard reaction typically occurs at temperatures over 285° F. Thus, by heating the meat over this temperature, the meat is imparted with an enhanced flavor. Other meat treatments, including seasoning, tenderizer application and marinating can also enhance the cooking process for meat. Other non-meat food items also benefit, for either similar or different reasons, from cooking with or without seasoning or other treatments.

Normal barbecuing time to achieve medium rare meat is 8-9 minutes and the average person has a difficult time accurately guessing the desired internal temperature. The heating occurs primarily by conduction, from bottom to top through and into lower portions of the cut of meat. To some extent, radiation and convection heat transfer may also be involved to heat all surfaces of the cut of meat. Thus, to heat middle and upper portions of the meat, either the meat is flipped or the heat is applied slowly to avoid overcooking the bottom of the meat cut, or lower portions are allowed to be somewhat overheated. These are all suboptimal processes when even heating and speed are desired.

Meat is 75% water. The longer meat is on a grill the more moisture is lost. Shorter cooking times means less moisture loss, but at the risk of overcooking portions of the meat. Thus, with prior art single side cooking, even with flipping, a less than optimal drying or overcooking is experienced. Accordingly, a need exists for a tool which can conduct heat to food items evenly from multiple surfaces to accelerate cooking times and maintain moisture, with an easy to use cooking tool for use on a barbecue or cooktop or other heat source.

### SUMMARY OF THE INVENTION

This invention relates to an improvement in searing and cooking meat whereby a bottom cooking pan or plate and a separate top cooking pan or plate are heated simultaneously to an equal desired searing temperature before use. Once the desired searing temperature is reached on the two plates, the meat is then placed on the bottom plate and immediately thereafter the top plate is placed on the top side of the meat directly over the bottom plate. This improved method sears both sides of the meat simultaneously while raising the inside temperature of the meat to the desired temperature and doneness in less than half the time of the common searing and cooking method. Also, there is no need to transfer the meat to another grilling, baking or frying apparatus where further flipping and cooking would be required.

The two plates can be adjacent to each other, such as with the top plate stacked on the bottom plate during heating before use, or they can be heated separately and then brought together with the food item therebetween. Handles are preferably provided, with one candle on each plate, to facilitate positioning thereof relative to a food item.

In one embodiment, posts are provided extending from one plate and holes are provided in the other plate which match position of the posts. The posts fit within the holes so that the two plates can be registered together in a relatively precise desired position. Such posts also help to keep cylindrical or spherical food items from rolling out from between the top plate and the bottom plate. With the two plates held together, such as with the posts and holes, a user can merely carry the bottom plate, and the entire assembly can be securely carried, along with a food item.

In a further embodiment, a grease trough is provided on the bottom plate near a perimeter edge thereof, to keep grease from flowing off of the bottom plate. In this embodiment, posts are replaced with elongate guide bars which fit into slots in the top plate, to keep the top plate and bottom plate aligned. A thermometer is also preferably attached to an upper surface of the top plate to measure a temperature of the top plate, for guidance both before and after cooking with the searing tool of this invention.

After the two plates have been heated, a food item is placed between the two plates and the two plates are brought into contact with two opposing sides of the food item. The plates are then removed from heat (or heat is removed from the two plates). Thus, the only (or at least a majority of) heat transferred to the food item is heat which has been previously passed into the plates and which is then transferred out of the plates and into the food item. In this way, the top plate and bottom plate, which preferably have a similar mass and/or are formed from similar materials, cool down relatively simultaneously, so that a similar amount of heating occurs into the food item on both of the opposing surfaces of the food item.

### OBJECTS OF THE INVENTION

Accordingly, a primary object of the present invention is to provide a food searing tool which can sear a food item both from below and above simultaneously.

Another object of the present invention is to provide a two plate food searing item which transfers heat at a similar rate both down into the food item and up into the food item.

Another object of the present invention is to provided food searing tool which maintains moisture of a food item being cooked by heating of the food item more rapidly by cooking from two separate surfaces of the food item simultaneously and at similar rates, and also to sear surfaces of the food item to reduce moisture loss through surfaces of the food item.

Another object to the present invention is to improve flavor in food items which have been cooked, by cooking the food items more rapidly and to better maintain moisture of the food items.

Another object of the present invention is to provide a food searing tool which is compatible with a variety of heat sources including barbecue grills, cooktops and other heat sources.

Another object to the present invention is to provide a food searing tool with two separate plates which are held together and prevented from rolling or sliding relative to each other in lateral directions, to keep the top plate directly above the bottom plate and to keep the top plate from falling away from the bottom plate during use, especially with cylindrical or spherical food items therebetween.

Another object of the present invention is to provide a food searing tool which can capture grease created by the cooking of a food item, or otherwise, by providing a trough adjacent to a perimeter of the bottom plate.

Other further objects of the present invention will become apparent from a careful reading of the included drawing figures, the claims and detailed description of the invention.

### BRIEF DESCRIPTION OF THE DRAWINGS

FIG. 1 is a perspective review of the food searing tool of this invention according to one embodiment.

FIG. 2 is a front elevation view of that which is shown in FIG. 1.

FIG. 3 is a front elevation view of that which is shown in FIG. 1, but with the top plate brought into direct contact with the bottom plate, such as for heating thereof together in a stacked configuration.

FIG. 4 is a top plan view of the top plate of FIG. 1.

FIG. 5 is a front elevation view of that which is shown in FIG. 4.

FIG. 6 is a top plan review of the bottom plate of the food searing tool.

FIG. 7 is a front elevation view of that which is shown in FIG. 6.

FIG. 8 is a perspective view of an alternative embodiment of that which is shown in FIG. 1, with the bottom plate featuring posts extending upwardly therefrom, and with the top plate featuring holes which accommodate the posts to keep the top plate aligned with the bottom plate.

FIG. 9 is a front elevation view of that which is shown in FIG. 8.

FIG. 10 is a front elevation view of that which is shown in FIG. 8, but with the top plate shown directly adjacent to the bottom plate, such as during heating of the plates before use in cooking.

FIG. 11 is a top plan view of the top plate of FIG. 8.

FIG. 12 is a front elevation view of the top plate of the alternative embodiment of FIG. 8.

FIG. 13 is a top plan view of the bottom plate of the alternative embodiment shown in FIG. 8.

FIG. 14 is a front elevation view of the bottom plate according to this alternative embodiment.

FIG. 15 is a perspective view of a top plate according to a second alternative searing device, according to a third embodiment of this invention.

FIG. 16 is a perspective view of a bottom plate configured to work with the top plate of FIG. 15.

FIG. 17 is a perspective view combining FIGS. 15 and 16 together and showing how the top plate and bottom plate interact together for searing of a food item located between the top plate and the bottom plate.

FIG. 18 is a full sectional front elevation view of that which is shown in FIG. 16.

FIG. 19 is a top plan view of a combination of the top plate and the bottom plate of this second alternative embodiment.

FIG. 20 is a bottom plan view of that was shown in FIG. 17.

FIG. 21 is a left end elevation view of that which is shown in FIG. 17.

FIG. 22 is a right end elevation view of that shown in FIG. 17.

FIG. 23 is a front elevation view of that which is shown in FIG. 17.

### DESCRIPTION OF THE PREFERRED EMBODIMENT

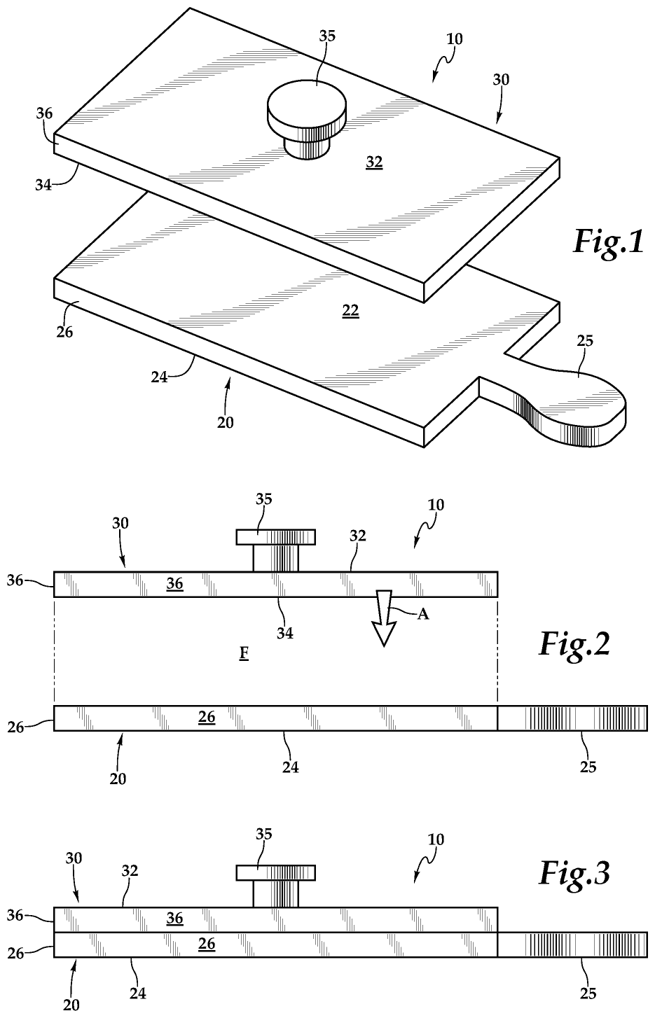

Referring to the drawings, wherein like reference numerals represent like parts throughout the various drawing figures, reference numeral 10 is directed to a food searing tool which has a food space F into which a food item is placed (FIGS. 1-3), after heating of the two plates 20, 30 of the tool 10. With the plates 20, 30 having similar size and being formed of similar material, and being initially heated to a similar temperature, heat transferred down into the food item from the top plate and up into the food item from the bottom plate occur at similar rates and to a similar extent. This results in both fast food cooking and searing of surfaces; decreasing loss of moisture during cooking and improving flavor.

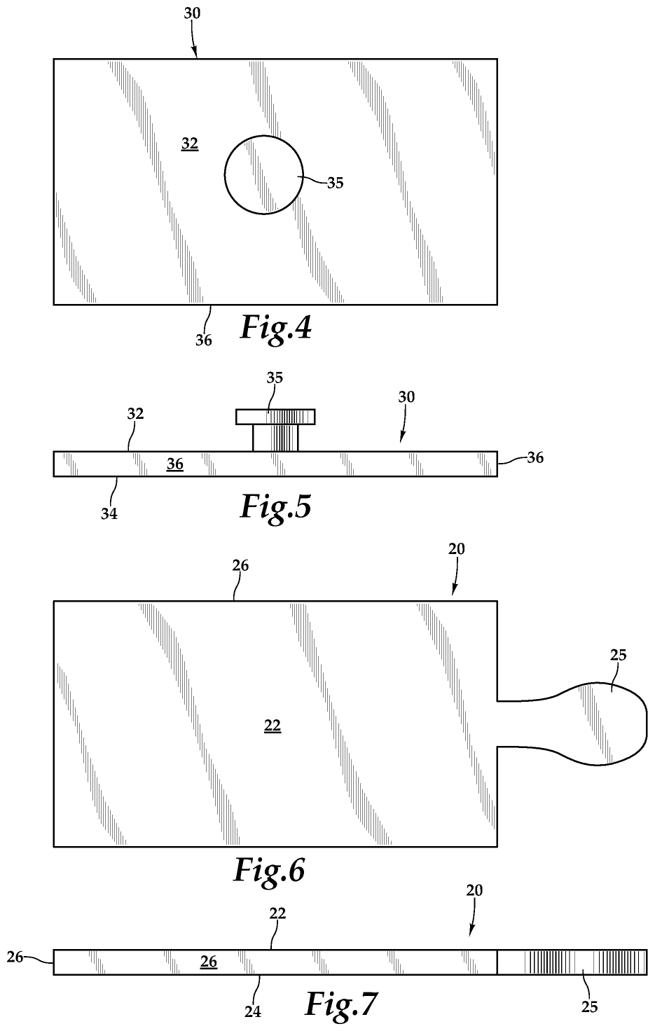

In essence, and with particular reference to FIGS. 1-7, basic details of the searing tool 10 are described, according to a first and relatively simple embodiment. In this embodiment, the tool 10 includes a bottom plate 20 and a top plate 30. These plates 20, 30 have a similar size and shape, including similar thickness, and preferably formed of similar materials. The bottom plate 20 includes an extension 25 providing a form of handle for the bottom plate 20, according to this embodiment. The top plate 30 includes a handle in the form of a knob 35 in this particular embodiment. A food space F between the top plate 30 and bottom plate 20 can contain a food item therein.

The plates 20, 30 are first heated to a similar temperature. According to one method, the top plate 30 is placed directly upon the bottom plate 20 (FIG. 3) and the bottom plate 20 is placed upon a heat source, such as a barbecue grill. With the plates 20, 30 formed of a material having a high coefficient of heat transfer, such as cast-iron, the top plate 30 and bottom plate 20 will have a similar temperature during and after heating. Once the plates 20, 30 are heated to a desired temperature, a food item is placed into the food space F between the plates 20, 30. The plates 20, 30 are then removed from the heat source along with the food item, so they continue heating up the food item by transfer of heat from the plates 20, 30 to the food item. This method is in contrast to the typical method of heating from the heat source through one of the plates, such as the bottom plate 20. Even heating from both top and bottom thus occurs for the food item with this invention.

With continuing reference to FIGS. 1-7, particular details of the searing tool 10 are described according to this first embodiment. The bottom plate 20 is preferably a thin rigid monolithic structure formed of a unitary mass of material, in one embodiment being cast iron. This bottom plate 20 includes a cooking surface 22 opposite a heating surface 24, which surfaces 22, 24 are preferably parallel with each other and with their spacing defining a thickness of the bottom plate 20 therebetween.

A perimeter edge 26 forms a side of the bottom plate 20, with the perimeter edge 26 extending from the cooking surface 22 down to the heating surface 24. The perimeter edge is preferably perpendicular to the cooking surface 22 and heating surface 24. The bottom plate 20 preferably has a generally rectangular form defined by the perimeter edge 26. Other shapes could alternatively be provided, such as square or round.

To facilitate handling of the bottom plate 20, an extension 25 preferably extends from one of the shorter sides of the perimeter edge 26. This extension 25 acts as a form of handle which can be readily gripped by a user for moving of the bottom plate 20 (and any items placed upon the bottom plate 20) through manipulation of this extension 25. In a simple embodiment, this extension 25 is formed of a similar material as other portions of the bottom plate 20. Thus, a user typical utilizes an oven mitt, hot pan holders, or some other protective instrument to avoid being burned when handling the extension 25 after the bottom plate 20 has been heated. As an alternative, the extension 25 or other handle on the bottom plate 20 could be configured to be cooler than other portions of the bottom plate 20 for handling without protection (or less protection).

In one embodiment, the bottom plate 20 is formed of cast-iron. Other metals or other materials could conceivably be utilized to form the bottom plate 20, such as aluminum or copper. The material forming the bottom plate 20 preferably has a high coefficient of heat transfer for rapid heating of a food item adjacent thereto, such as within the food space F between the bottom plate 20 and top plate 30. Furthermore, the thickness of the bottom plate 20 is preferably sufficient so that there is sufficient heat contained within the bottom plate 20 to allow for a desired level of heat transfer and associated cooking of a food item adjacent to the bottom plate 20, at least sufficient to thoroughly cook the food item halfway through, from the edge of the food item to the center of the food item that is located adjacent to the bottom plate 20.

The top plate 30 preferably has a form similar to the bottom plate 20. Thus, in such an example, the top plate 30 includes an upper surface 32 opposite a lower surface 34 with these surfaces 32, 34 generally parallel with each other and spaced apart by a thickness of the top plate 30. A perimeter 36 is preferably perpendicular to the surfaces 32, 34 and extends between the surfaces 32, 34 defining a thickness of the top plate 30. The top plate 30 is preferably rectangular, as defined by the contour of the perimeter 36. A knob 35 extends from the upper surface 32 to act as a form of handle. This knob 35 could be formed of a similar material as that forming the top plate 30, or could be a separate material, and conceivably an insulated material to allow for direct handling of the knob 35.

As with the bottom plate 20, the top plate 30 preferably has a similar thickness and this thickness is sufficient so that heat capacitance of the top plate 30 is sufficient to heat the food item halfway through, from the upper portion of the food item to a center of the food item. Most preferably, the top plate 30 is formed of a similar material to that from which the bottom plate 20 is formed. By the plates 20, 30 having a similar size and thickness, and being formed of a similar material, they will have a similar mass. By being heated to a similar temperature, all of the factors which govern heat transfer from the plates 20, 30 are similar to each other. Thus, conduction heat transfer from the plates 20, 30 to the food item (both an amount of eat transferred and a rate of heat transfer) will occur at a similar rate and to a similar extent into opposing services of the food item. The food item can thus be most rapidly cooked and cooked evenly.

When the plates 20, 30 are described as having similar mass and having similar amounts and/or rates of heat transfer to the food item, such language contemplates quantities closer to equal than to half or double that of the other plate 20, 30. Thus, if one plate 20, 30 has a mass of 1.0 kg, the other plate 20, 30 would have a mass between 0.5 kg and 2.0 kg. Similarly, if one plate 20, 30 transfers 50 kilojoules in one minute, the other plate 20, 30 would transfer between 25 and 100 kilojoules in one minute.

In one embodiment, the food item is a cut of meat. The plates 20, 30 are heated up to approximately 500° E The meat is then placed between the plates 20, 30 and the plates 20, 30 and meat are removed from a heat source. The plates 20, 30 will begin decreasing in temperature as heat is transferred from the plates 20, 30 to the cut of meat, and also to some extent are transferring heat to surrounding air and other structures. Preferably the plates 20, 30 are placed so that the bottom plate 20 is resting upon a surface which is at least somewhat insulated (including by air). In one embodiment, a grill on an upper rack of a barbecue provides an appropriate insulated location. With the lid closed, smoke and confinement can impart a desirable barbecue flavor. As another option, a propane grill can be turned off when cooking starts to facilitate balanced cooking from both opposite directions. The heat transfer is highest when the difference in temperature between the food item and the plates 20, 30 is greatest. As the plates 20, 30 cool, this rate of heat transfer will decrease.

The food item is heated at its surface first where it is in contact with the plates 20, 30. Once the core of the food item has been heated sufficiently, the food item can be removed from the plates 20, 30. For some food items, such as meat, different consumers may desire the meat to be cooked a different amount. Specific times can be established to achieve such a desired cooking of the meat item. For instance, 2.0 minutes to cook a one inch steak to “medium rare,” or 2.5 minutes to cook to “medium.” Similarly, other food items can be cooked from two sides between the plates 20, 30 in a rapid fashion, which can be studied and catalogued for later optimal repetition. In addition to rapid heating, the surfaces of the two plates 20, 30 coming into contact with the food item sear the food items somewhat and tend to lock in moisture within the food item, giving it a moist and desirable flavor.

Beneficially, the plates 20, 30 are formed with the cooking surface 22 and lower surface 34 able to be in intimate contact during heating. This keeps the high rate of heat transfer material forming the plates at a similar temperature in thermal equilibrium during heating. A thermal probe or other thermometer measuring the upper surface 32 of the top plate 30 indicates that the entire tool 10 is ready when this upper surface is 500° F. or other target desired starting temperature.

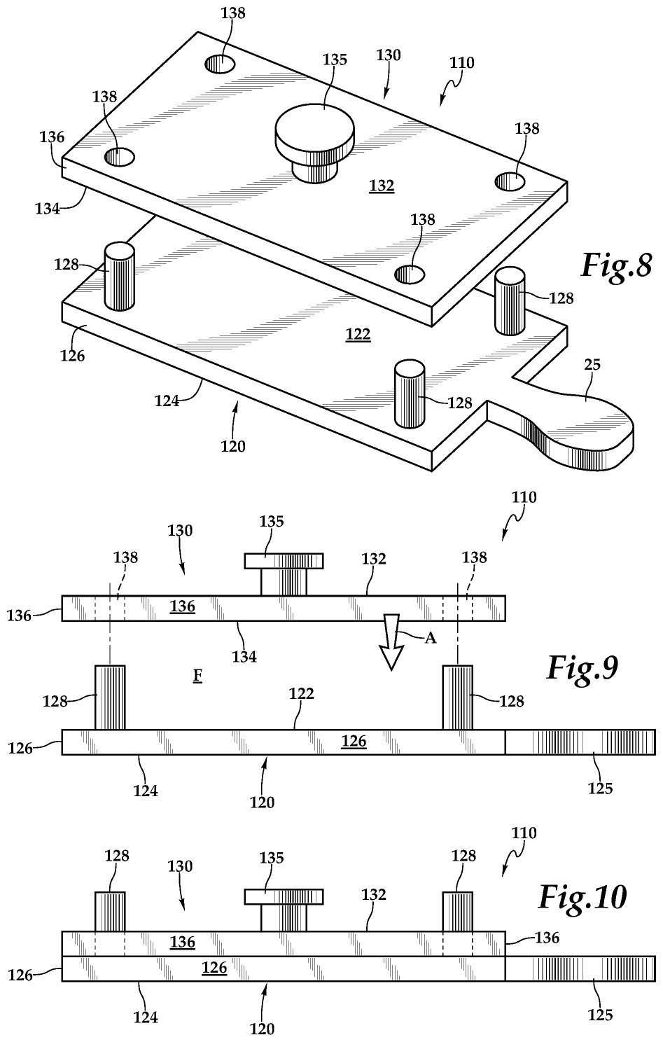

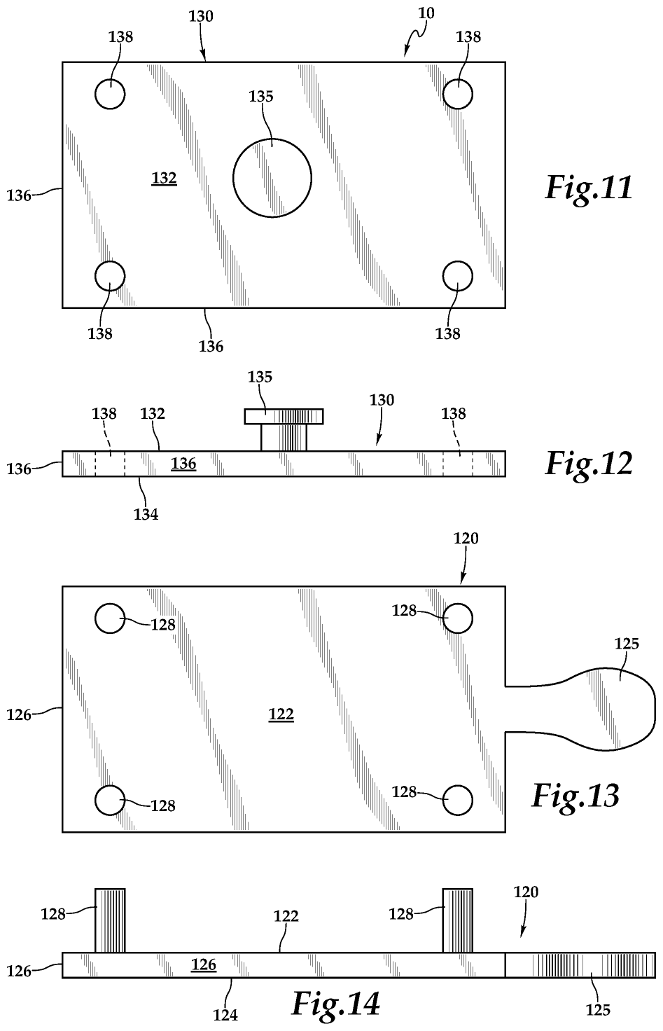

With particular reference to FIGS. 8-14, details of this invention are described according to a first alternative embodiment. This first alternative embodiment is in many ways similar to the searing tool 10 of the embodiment described above, so that this alternative searing tool 110 is described in most detail with regard to unique details of this alternative searing tool 110. The alternative searing tool 110 includes a bottom plate 120 and top plate 130 which are in most respects similar to the top plate 30 and bottom plate 20 of the searing tool 10 of FIGS. 1-7. The bottom plate 120 thus has a cooking surface 122 opposite a heating surface 124, and with the perimeter edge 126 extending therebetween. Extension 125 provides a handle at one end of the bottom plate 120.

The top plate 130 includes an upper surface 132 opposite a lower surface 134 forward with the perimeter 136 between the upper surface 132 and lower surface 134. Extension 125 provides a handle at one end of the bottom plate 120. The top plate 130 includes an upper surface 132 opposite a lower surface 134, with a perimeter 136 between the upper surface 132 and lower surface 134. A knob 135 provides a handle for the top plate 130.

Uniquely with this alternative searing tool 110, the bottom plate 120 includes posts 128 extending perpendicularly upwardly from the cooking surface 122 of the bottom plate 120. The posts 128 are preferably cylindrical in form with a circular cross-section. Holes 138 are formed in the top plate 130 which extend entirely through the top plate 130 from the lower surface 134 to the upper surface 132. The holes 138 and posts 128 preferably have a similar form both in size, shape and location, so that the posts 128 can fit into the holes 138. Enough tolerance is provided to allow the posts 128 to move freely into the holes 138, but with minimal movement relative to each other, other than vertically.

In the embodiment disclosed, the alternative searing tool 110 features four posts 128 and four holes 138, with the posts 128 and holes 138 near corners of the plates 120, 130. Such a location is convenient to keep the top plate aligned with the bottom plate 120. The posts 128 and holes 138 both increase contact between the top plate 130 and bottom plate 120 for rapid heating therebetween during a heating step. Furthermore, with a food item between the plates 120, 130 the posts 128 and holes 138 maintain contact and tend to maintain thermal equilibrium (common temperature) between the two plates 120, 130 for even heating/cooking of the food item.

Also, the posts 128 and holes 138 keep the top plate 130 for moving relative to the bottom plate 120 after heating, and when a food item has been placed into a food space F between the plates 120, 130 and the top plate 130 has been moved down onto the bottom plate 120 (along arrow A of FIG. 9). For instance, when moving the entire alternative searing tool 110 from a heat source, it is desirable to be able to do so with one hand gripping the extension 125. By having the top plate 130 held to the bottom plate 120 through interaction of the holes 138 with the posts 128, such transfer to a cooking location away from the heat source can most easily and/or effectively occur. This is especially true for rounded food items, such as asparagus, hotdogs and other cylindrical or round food items to be cooked. The posts 128 can also tend to keep hotdogs etc. from rolling off of the bottom plate 120 or otherwise becoming laterally dislodged, especially during movement of the alternative searing tool 110.

The posts 128 also assist in keeping food items such as hotdogs from rolling off of the bottom plate 120, both before and after the top plate 130 has been placed onto the bottom plate 120. The posts 128 and holes 138 provide one form of guide structure to keep the top plate 130 and bottom plate 120 aligned together, and without relative motion other than in a vertical direction, to accommodate food items of different heights therebetween.

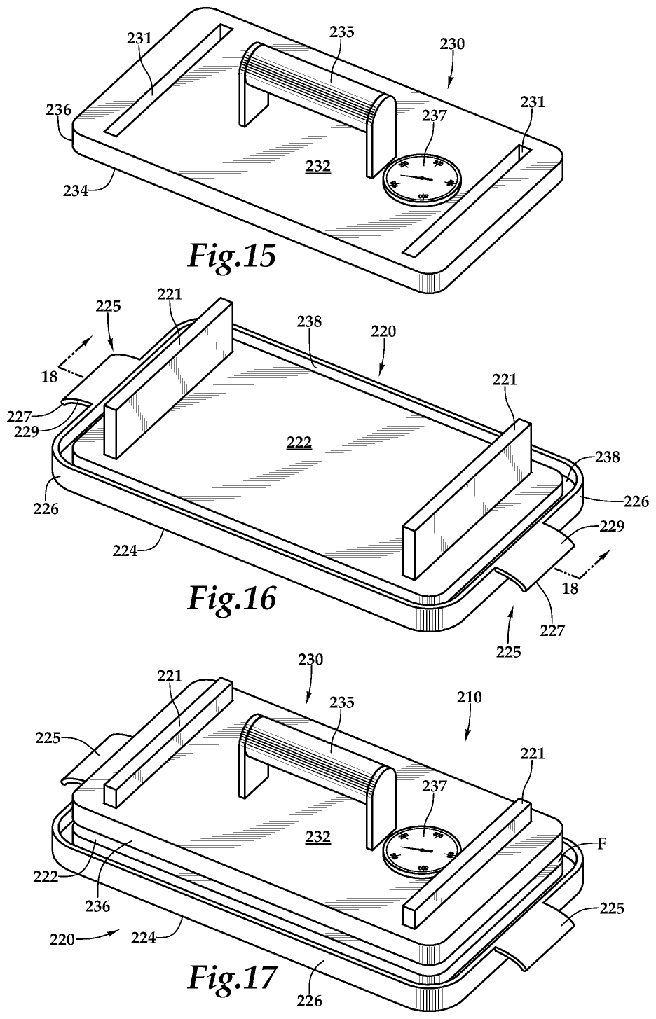

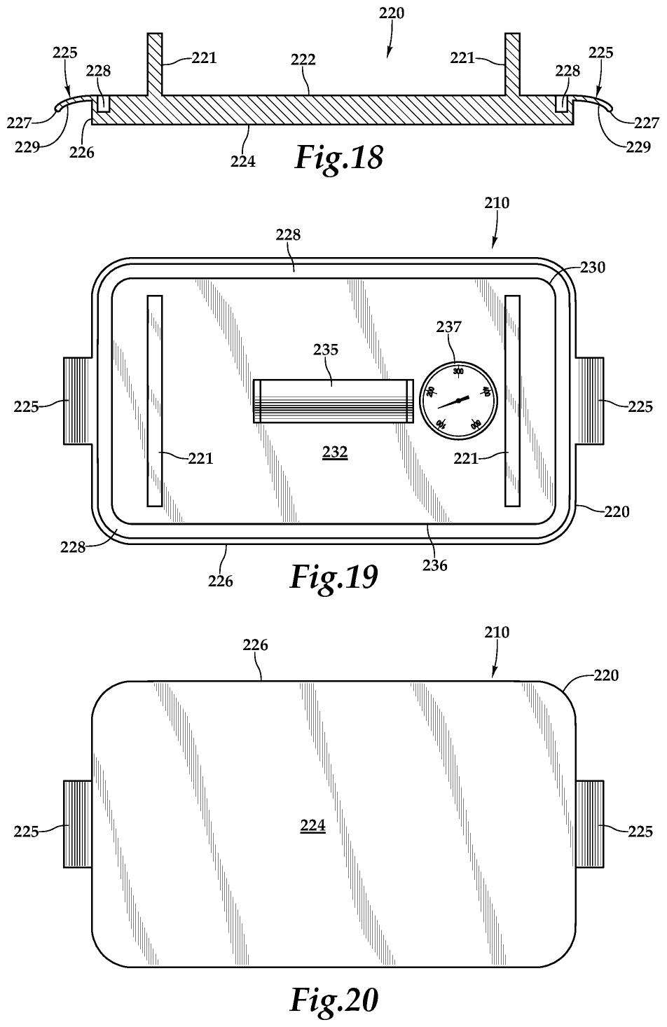

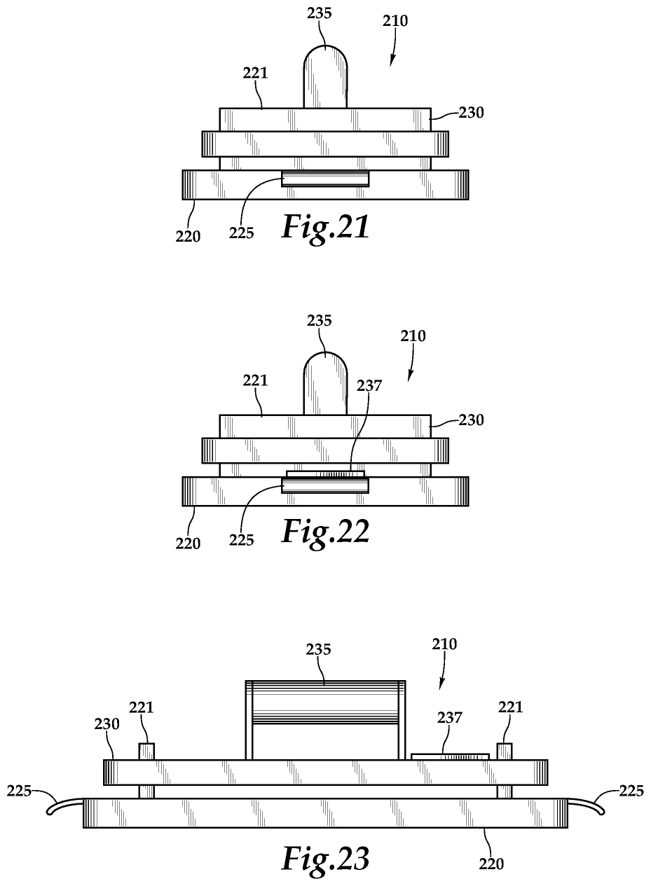

With particular reference to FIGS. 15-23, details of a second alternative searing tool 210 are described, according to a further alternative embodiment. This second alternative searing tool 210 is similar to the previously described searing tools except where more particularly described herein.

The second alternative searing tool 210 includes a bottom plate 220 and top plate 230 which are configured to be oriented adjacent to each other with the food space F therebetween. These plates 220, 230 are preferably similar in size, but in this embodiment, the top plate 230 is slightly smaller, such that a trough 228 in a cooking surface 222 of the bottom plate 220 adjacent to a perimeter edge 226 of the cooking surface 222, is exposed slightly outboard of a perimeter 236 of the top plate 230. The bottom plate 220 includes a heating surface 224 offset the cooking surface 222 and with a perimeter edge 226 bounding the surfaces 222, 224 and defining a thickness of the bottom plate 220. The trough 228 extends only partially down into the bottom plate 230 so that grease coming off of the food items being cooked between the plates 220, 230 can be captured within this trough 228. Guide bars 221 act as a form of a guide structure extending up from the bottom plate 220.

Tabs 225 extend from opposing lateral edges of the bottom plate 220 at the perimeter edge 226 thereof. These tabs 225 act as a form of handle for the second alternative searing tool 210. Each tab 225 preferably extends to tips 227, with the tabs 225 curving along arches 229 as they extend out to the tips 227. With arches 229, hot grease is discouraged from pooling where it might be touched by user and cause a burn, or be more difficult to clean. The tabs 225 are sufficiently long and thin that grouping of the tabs 225 near the tips 227 can occur with lesser (or no) protection from excessive heat.

The top plate 230 includes an upper surface 232 opposite a bottom surfaces 234 and with the perimeter 236 defining a thickness of the top plate 230 between the surfaces 232, 234. In one embodiment, the top plate 230 is made slightly thicker than the bottom plate 220, so that the slightly smaller perimeter size of the top plate 230 is compensated for by greater thickness, so the volume/mass of the plates 220, 230 can still be similar.

Slots 231 extend through the top plate 230 and have a similar size and location to the guide bars 221. The slots 231 can thus fit over the guide bars 221 in a manner coupling the top plate 230 to the bottom plate 220 in a manner resisting all relative motion other than vertical relative motion between the top plate 230 and bottom plate 220. Lateral displacement of the plates 220, 230 is resisted by the interaction of the slots 231 and guide bars 221 fitting together (with the food item within the food space F therebetween). Also, contact between the bars 221 and slots 231 helps to maintain thermal equilibrium for even heating/cooking of a food item therebetween.

The top plate 230 preferably includes a handle 235 thereon. In this embodiment, the handle has two risers with a crossbar therebetween, with the crossbar grippable by a user. This crossbar could be formed of a material having a low rate of heat transfer (e.g. wood), and with a geometry to facilitate handling with little or no protection from heat.

A thermometer 237 is preferably formed in (or attached to) the top plate 230, and in particular on the upper surface 232 of the top plate 230. With such a position, when the bottom plate 220 is placed upon a source of heat (with the top plate 230 stacked thereon), such as a barbecue grill which is currently heated, or an electric cooktop, the last portion of the assembly of plates 220, 230 to reach a desired temperature will be the upper surface 232 of the top plate 230. Once this upper surface 232 of the top plate 230 has achieved a desired temperature, generally all portions of each of the plates 220, 230 will be at least at this temperature (other than perhaps the handles).

With regard to the guide elements, while the posts 128 in the alternatives searing tool 110 (FIGS. 8-14) and the guide bars 221 of the second alternative searing tool 210 (FIGS. 15-23) are both shown extending up from the bottom plates 120, 220, it is conceivable that these guide structures could extend instead down from the top plate 130, 230 into appropriately shaped holes 138, 231 in the bottom plates 120, 220, by reversing the position of such guide structures and associated holes/recesses.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When embodiments are referred to as “exemplary” or “preferred” this term is meant to indicate one example of the invention, and does not exclude other possible embodiments. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1: A food searing tool, comprising in combination:
a bottom plate;
said bottom plate having a first surface opposite a second surface, and with a bottom plate thickness between said first surface and said second surface;
a top plate;
said top plate having a first surface opposite a second surface, and with a top plate thickness between said first surface and said second surface.
a majority of said bottom plate formed of a primary material;
a majority of said top plate also formed of said primary material; and
said mass of said bottom plate and said mass of said top plate having a ratio closer to 1:1 than to 2:1 or 1:2.

2: The tool of claim 1 wherein at least one of said top plate and said bottom plate includes a handle thereon.

3: The tool of claim 2 wherein said top plate includes at least one handle thereon and said bottom plate includes at least one handle thereon.

4: The tool of claim 3 wherein said handle on said bottom plate includes an extension extending laterally from other portions of said bottom plate, said extension formed of said primary material and said extension having a thickness matching said bottom plate thickness.

5: The tool of claim 4 wherein said handle on said top plate includes a knob extending from a portion of said top plate opposite side bottom plate, and centered away from a perimeter of said top plate.

6: The tool of claim 1 wherein said bottom plate has a trough extending down into said first surface and away from said top plate, said trough located inboard of a perimeter of said bottom plate, said top plate having a perimeter located inboard of said trough when said top plate is centered above said bottom plate.

7: The tool of claim 1 wherein said first surface of said top plate is located further from said bottom plate than said second surface of said top plate, said first surface of said top plate having a thermometer thereon with a temperature display visible from above said first surface of said top plate.

8: The tool of claim 1 wherein guide structures are associated with said bottom plate and said top plate, said guide structures including complementary male and female structures, with said male structures located in a fixed position on one of said top plate and said bottom plate, and with said female structures located in a fixed position on one of said bottom plate and said top plate, said male structures and said female structures located to fit together when said top plate is located adjacent to and above said bottom plate.

9: The tool of claim 8 wherein said guide structures include posts extending up from said first surface of said bottom plate and holes passing through said top plate from said first surface to said second surface, said holes in said top plate sized to allow said posts in said bottom plate to pass therethrough, said holes in said top plate located in positions matching locations of said posts extending up from said bottom plate, such that said top plate can extend vertically down onto said bottom plate with said holes in said top plate having said posts passing therethrough.

10: The tool of claim 8 wherein said guide structures include at least one bar and at least one slot, said bar and said slot sized to fit together, one of said bar and said slot formed on said top plate and one of said slot and said bar formed on said bottom plate;
wherein said top plate includes a handle including a knob extending from a first surface of said top plate opposite said bottom plate, said knob centered inboard of a perimeter of said top plate; and
said bottom plate including lateral edges with tabs extending laterally from said lateral edges on portions of said bottom plate opposite each other, said tabs grippable to lift and carry said bottom plate with hands of a user.

11: A method for searing food from opposing surfaces simultaneously, the steps including:
heating a food searing tool having a bottom plate with a first surface opposite a second surface, and with a bottom plate thickness between the first surface and the second surface, and a top plate with a first surface opposite a second surface, and with a top plate thickness between the first surface and the second surface, and with the top plate in contact with the bottom plate;
spacing the top plate from the bottom plate to create a food space therebetween;
placing a food item between the top plate and the bottom plate and within the food space; and
removing the food searing device from at least a portion of heat from said heating step, after said heating step.

12: The method of claim 11 including the further step of holding the food item between the top plate and the bottom plate for a desired time to match a desired amount of cooking of the food item.

13: The method of claim 11 wherein said heating step includes a thermometer on the top plate, and with a surface of the bottom plate opposite the top plate located closest to a source of heat, and ending said heating step when temperature read by said thermometer equals a desired temperature for the top plate and the bottom plate.

14: The method of claim 11 wherein said placing step is followed by transfer of heat from said top plate to said food item and from said bottom plate to said food item, an amount of heat transferred from the top plate to the food item and an amount of heat transferred from the bottom plate to the food item having a ratio closer to 1:1 than to 2:1 or 1:2.

15: The method of claim 14 wherein said heating step includes a majority of the bottom plate formed of a primary material, and majority of the top plate also formed of the primary material, and a mass of the bottom plate and a mass of the top plate having a ratio closer to 1:1 than to 2:1 or 1:2.

16: The method of claim 11 wherein said spacing step includes at least one handle on at least one of the plates, and gripping the handle to cause a plate coupled to the handle to move relative to the other plate.

17: The method of claim 16 wherein at least one handle is located upon the top plate and at least one handle is located up on the bottom plate, the handle on the bottom plate including an extension extending laterally from other portions of the bottom plate, the extension having a thickness matching the bottom plate thickness, and the handle located on the top plate including a knob extending from a portion of the top plate opposite the bottom plate, and centered away from a perimeter of the top plate.

18: The method of claim 11 including aligning the top plate with the bottom plate through complementary guide structures on the bottom plate and the top plate, during at least a portion of said removing step, the complementary guide structures maintaining contact for heat transfer therebetween when one plate is hotter than the other plate.

19: The method of claim 18 wherein the complementary guide structures include posts extending up from the first surface of the bottom plate and holes passing through the top plate from the first surface to the second surface, the holes in the top plate sized to allow the posts in the bottom plate to pass therethrough, the holes in the top plate located in positions matching location of the posts extending up from the bottom plate, such that the top plate can extend vertically down onto the bottom plate with the holes in the top plate having the posts passing therethrough.

20: The method of claim 18 wherein said complementary guide structures include at least one bar and at least one slot, the bar and the slot sized to fit together, one of the bar and the slot formed on the top plate and one of the slot and the bar formed on the bottom plate.
